(19) United States
(12) Patent Application Publication
(10) Pub. No.: US 2004/0236747 A1
(43) Pub. Date: Nov. 25, 2004

(54) Data processing systems

(76) Inventors: Morton G. Swimmer, Adliswil (CH); Michael Waidner, Au (CH); Andreas Wespi, Niederhasli (CH)

Correspondence Address: Intellectual Property Law Dept., IBM Corporation, P.O. Box 218, Yorktown Heights, NY, 10598, US

(21) Appl. No.: 10/791,992

(22) Filed: Mar. 3, 2004

(30) Foreign Application Priority Data
Mar. 6, 2003 (EP) 03005060.3

(51) Int. Cl. G06F 7/00

(52) U.S. Cl. 707/9

(57) ABSTRACT

Methods, apparatus and systems for controlling access to an object in a data processing system comprises: receiving a request to access the object from a task; classifying the access request into one of critical and non-critical classes in dependence on stored access control data associated with the object and the task; granting the task access to the object and storing data indicative of the access in an access log if the access is classified into the non-critical class; and in the event that the access is classified into the critical class, granting or denying the task access to the object in dependence on the contents of the access log and the stored access control data.

### FIELD OF INVENTION

The present invention generally relates to data processing systems. It particularly relates to security in data processing systems, and especially to controlling access to resources in data processing systems.

### BACKGROUND OF THE INVENTION

For a general overview of security in data processing, see, for example, Simone Fischer-Huebner: IT-Security and Privacy, 2001 and Dorothy Denning: Cryptography and Data Security, 1982. An aspect of security in the data processing field is that of controlled access to objects or resources such as data files and the like. Such access control is typically implemented with reference to attributes of a user seeking access. The attributes might include, for example, subscription status, or clearance to read or write sensitive data. A data processing process in which performance of the process is dependent on one or more attributes of a user seeking to perform the process is typically referred to as a task. Examples of such tasks include reading from and writing to a classified data file.

In M. Abrams, J. Heaney, O. King, L. LaPadula, M. Lazear, I. Olson: Generalized Framework for Access Control: Towards Prototyping the ORGCON Policy, In Proceedings of the 14th National Computer Security Conference, Baltimore, October 1991, there is described a Generalized Framework for Access Control (GFAC) as shown in FIG. 1. The GFAC is typically implemented in software to implement one or more access control schemes in a data processing system comprising a central processing unit (CPU), memory subsystem, and input/output (I/O) subsystem all interconnected via a bus subsystem. The GFAC is typically stored in the memory for execution by the CPU.

Referring to FIG. 1, the GFAC comprises an Access Control Enforcement Facility (AEF) 10. The AEF 10 resides in a Trusted Computing Base (TCB) 20. The TCB 20 is a protected part of the data processing system, such as an operating system kernel. In operation, the AEF 10 receives an access request 30 from a subject 40. The subject 40 is typically manifested by its proxy. The proxy is a task which inherits access rights from the requesting subject 40. The subject 40 might for example be a user having defined access rights. Such access rights might include the right to read from a file or the right to write to a file. Access functions such as reading and writing may be regarded as having different sensitivities. For example, there may be more risk associated with a write operation to a file than with a read operation. In use, the AEF 10 blocks or grants requests 30 for access 100 to an object 110, such as a classified data file. However, the AEF 10 delegates decision making to an Access Control Decision Facility (ADF) 50. Specifically, on receipt of the request 30, the AEF 10 sends the ADF 50 a decision request 80. In response to the decision request 80, the ADF 50 generates a decision 90 indicating whether it has decided to grant or to deny the request 30. The ADF 50 refers to stored Access Control Information (ACI) 60 and stored Access Control Rules (ACR) 70 to make its decision.

The ACI 60 comprises the attributes of the subject 40 and the object 110. The ACR 70 comprises a set of rules defining whether or not access to a given object can be granted to the subject 40 based on the attributes of the subject 40. In dependence on the decision 90 received from the ADF 50, the AEF 10 either grants or denies the subject 40 access 100 to the object 110. For simple privacy and security policies, the decision process can be performed quickly. However, more computation is needed when the ACR 70 specifies more complicated rules. Accordingly, the decision may be delayed, thus limiting system performance. Furthermore, some rules may require knowledge of prior accesses to make a decision. This brings additional delay and complicates implementation of the GFAC. It would be desirable to avoid such delays and complexity.

### SUMMARY OF THE INVENTION

Therefore, in one aspect the present invention provides methods, apparatus and systems for controlling access to an object in a data processing system. An example method comprising: receiving a request to access the object from a task; classifying the access request into one of critical and non-critical classes in dependence on stored access control data associated with the object and the task; granting the task access to the object and storing data indicative of the access in an access log if the access is classified into the non-critical class; and, in the event that the access is classified into the critical class, granting or denying the task access to the object in dependence on the contents of the access log and the stored access control data.

Preferably, the method comprises, in the event that the access is classified into the non-critical class, granting or denying the task access to the object in dependence on the access control data, and storing data indicative of the grant or denial in the access log.

Viewing the present invention from another aspect, there is now provided apparatus for controlling access to an object in a data processing system, the apparatus comprising: an access control data store for storing access control data associated with the object and the task; an access log; access control logic for receiving a request to access the object from a task; decision classifier logic, connected to the access control logic, the access control data store, and the access log, for classifying the access request into one of critical and non-critical classes in dependence on the access control data, and, in the event that the access is classified into the non-critical class, for granting the task access to the object and storing data indicative of the access in the access log; and, access control decision logic connected to the access control logic, the access log, the access control data store, and the decision classifier logic, for, in the event that the access is classified into the critical class, granting or denying the task access to the object in dependence on the contents of the access log and the access control data. The present invention extends to a data processing system comprising: a central processor unit; a memory; and access control apparatus as herein before described connected to the central processor unit and the memory.

The present invention is particularly although not exclusively applicable to privacy and data protection. For example, consider a process that accesses, processes, and discloses personal information. To enforce external privacy policy, such disclosures are marked towards outsiders as needing an immediate access control decision. For others, deferred access control might be sufficient. This does not prevent privacy violations within an enterprise, but it prevents such privacy violations producing illegal disclosures of personal information to outsiders.

### BRIEF DESCRIPTION OF THE DRAWINGS

The invention and its embodiments will be more fully appreciated by reference to the following detailed description of advantageous and illustrative embodiments in accordance with the present invention when taken in conjunction with the accompanying drawings, in which:

FIG. 1 is a block diagram of a Generalized Framework for Access Control (GFAC);

FIG. 2 is a block diagram of a data processing system;

FIG. 3 is a logical block diagram of an example of access control system embodying the present invention;

FIG. 4 is a flow chart associated with the access control system shown in FIG. 3;

FIG. 5 is another flow chart associated with the access control system shown in FIG. 3;

FIG. 6 is a more detailed logical block diagram of the access control system shown in FIG. 3;

FIG. 7 is a logical block diagram of another example of access control system embodying the present invention;

FIG. 8 is a flow diagram representative of multiple tasks executing in a data processing system;

FIG. 9 is a flow chart associated with the access control system shown in FIG. 7;

FIG. 10 is another flow chart associated with the access control system shown in FIG. 7;

FIG. 11 is a further flow chart associated with the access control system shown in FIG. 7; and,

FIG. 12 is yet another flow chart associated with the access control system shown in FIG. 7.

### DETAILED DESCRIPTION OF THE INVENTION

The present invention provides methods, systems and apparatus for controlling access to an object in a data processing system. In an example embodiment, a method comprises: receiving a request to access the object from a task; classifying the access request into one of critical and non-critical classes in dependence on stored access control data associated with the object and the task; granting the task access to the object and storing data indicative of the access in an access log if the access is classified into the non-critical class; and, in the event that the access is classified into the critical class, granting or denying the task access to the object in dependence on the contents of the access log and the stored access control data.

Preferably, the method comprises, in the event that the access is classified into the non-critical class, granting or denying the task access to the object in dependence on the access control data, and storing data indicative of the grant or denial in the access log.

The non-critical class may comprise a plurality of subclasses and the classifying may comprise classifying the access request into one of the subclasses in dependence on the stored access control data. In a preferred embodiment of the present invention, the subclasses comprise a first subclass and a second subclass. In a particularly preferred embodiment of the present invention, recovery data is stored in the access log if the access is classified into the second subclass. The access log may be inspected to identify bad grant decision based on the contents of the access log and the access control data and the method may comprise, on detection of a bad grant decision, rolling back any objects affected by the bad grant decision. The rolling back may comprise recovering data overwritten in the object. The inspection may be performed periodically. Alternatively, the inspecting may be performed during periods in which the data processing system is otherwise idle.

There is now also provided apparatus for controlling access to an object in a data processing system, the apparatus comprising: an access control data store for storing access control data associated with the object and the task; an access log; access control logic for receiving a request to access the object from a task; decision classifier logic, connected to the access control logic, the access control data store, and the access log, for classifying the access request into one of critical and non-critical classes in dependence on the access control data, and, in the event that the access is classified into the non-critical class, for granting the task access to the object and storing data indicative of the access in the access log; and, access control decision logic connected to the access control logic, the access log, the access control data store, and the decision classifier logic, for, in the event that the access is classified into the critical class, granting or denying the task access to the object in dependence on the contents of the access log and the access control data. The present invention extends to a data processing system comprising: a central processor unit; a memory; and access control apparatus as herein before described connected to the central processor unit and the memory.

The present invention also extends to a computer program element comprising computer program code means which, when loaded in a processor of a computer system, configures the processor to perform an access control method as herein before described.

As will be appreciated from the following detailed description of various embodiments of the present invention, the decision classifier logic acts as a coarse filter of decision requests. The access control decision logic subsequently acts as a fine filter of those decision requests passed to it via the decision triager.

By way of illustration of an advantage of the present invention, consider a computational process P desiring access to a secure object O, such as a stored data file, for which permission to access is needed. Permission might be granted in real time immediately before access is desired, as herein before described with reference to the conventional GFAC system. However, in general, checking and granting permissions beforehand limits performance. In preferred embodiments of the present invention, access is granted in advance based on assumptions regarding the permissions P might need. Checking permissions after the fact does not maintain security. However, such ex post facto checking of permissions allows later checks and audits to be performed by the system. The system may perform such audits periodically at defined intervals. Alternatively, the system may perform the audits during otherwise idle moments. Because audits of this nature can be performed off-line in otherwise idle moments, performance is less impeded. Techniques embodying the present invention are thus less intrusive than conventional techniques. Such audits enable forbidden actions produced by bad grant decisions to be identified. If changes brought about by forbidden actions are recorded, then recovery actions can be taken to return objects to desired states. Audit measures are generally regarded as sufficient for privacy purposes.

As indicated earlier, the non-critical class may comprise a plurality of sub classes. For example, in a particularly preferred embodiment of the present invention, there are three classes of actions: 1. informational access control; 2. immediate access control; and, 3. deferred access control. Classes 1 and 3 are subclasses of the non-critical class. Class 2 is the critical class.

A Class 1 action simply produces an audit record in the access log, but access is always granted. A class 1 action might be, for example, an action to read a publicly available document.

A Class 2 action involves prior checking of the access control data and the contents of the access log before it can be executed. A class 2 action is then permitted only if the access control data and the contents of the access log indicate that the permission can be granted. Otherwise, an exception is raised. A class 2 action might, for example, be write operation to a publicly available document.

In the case of a Class 3 action, permission need not be checked prior to a grant. Instead, permission is granted and the action is recorded in the access log. The action can then be inspected later, either at a defined interval or during an otherwise idle period, and the quality of the grant decision determined based on the access control data and other accesses recorded in the access log. If the inspection reveals that the access should have not been granted, an alert may be issued. The record of such accesses may include recovery data that enables changes to objects performed downstream of an access allowed via a bad grant decision to be rolled back to an acceptable state. For example, the recovery data may include changes made to a file via addition or deletion, or overwriting of content or example. A class 3 action might for example, be a read from a classified document.

It is noted that the present invention is particularly although not exclusively applicable to privacy and data protection. For example, consider a process that accesses, processes, and discloses personal information. To enforce external privacy policy, such disclosures are marked towards outsiders as needing an immediate access control decision. For others, deferred access control might be sufficient. This does not prevent privacy violations within an enterprise, but it prevents such privacy violations producing illegal disclosures of personal information to outsiders.

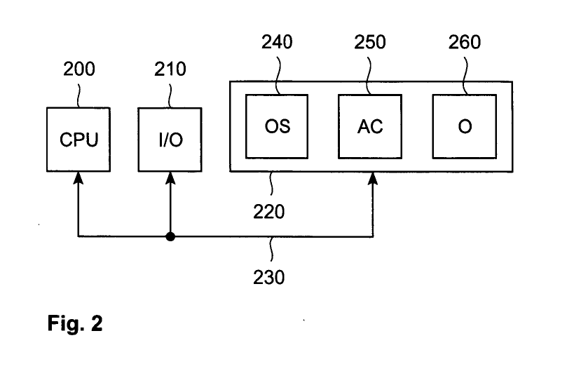

With reference to FIG. 2, a data processing system for implementing the present invention comprises a central processing unit (CPU) 200, a memory subsystem 220, an input/output (I/O) subsystem 210, and a bus subsystem 230 interconnecting the CPU 200, the memory subsystem 220, and the I/O subsystem 210. Operating system software 240 is stored in the memory subsystem 220. Similarly, at least one object 260 such as a data file is stored in the memory subsystem 220. Access to the object 260 is controlled via access controller software 250 also stored in the memory subsystem 220.

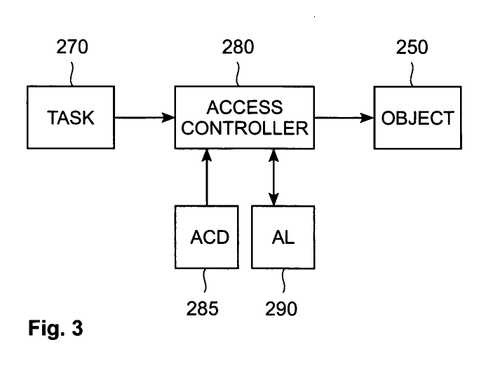

Referring now to FIG. 3, in operation, the access control software 250 configures the data processing system into logical arrangement in which access to the object 250 by a task 270 executing on the data processing system is controlled by an access controller 280.

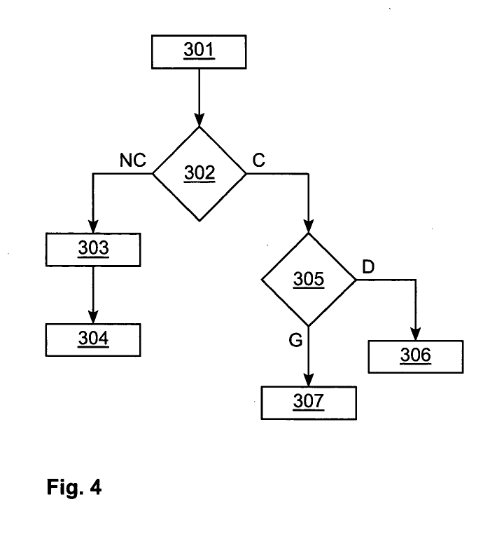

Referring to FIG. 4, on receipt of a request to access the object 250 from the task 270, at block 301, the access controller 280 classifies, at block 302, the request into one of critical and non-critical classes in dependence on stored access control data 285 associated with the object 250 and the task 270. If the access is classified into the non-critical class, the access controller 280 grants the task 270 access to the object at block 303 and stores data indicative of the access in an access log 290 at block 304. If the access is classified into the critical class, the access controller 280, at block 305, grants at block 307 or denies at block 306 the task access to the object 250 in dependence on the contents of the access log 290 and the stored access control data 285. The access controller 280 may be located in a TCB of the data processing system. As indicated earlier, the TCB is a protected part of the data processing system. In particularly preferred embodiments of the present invention, the TCB may be within a kernel portion of operating system 240.

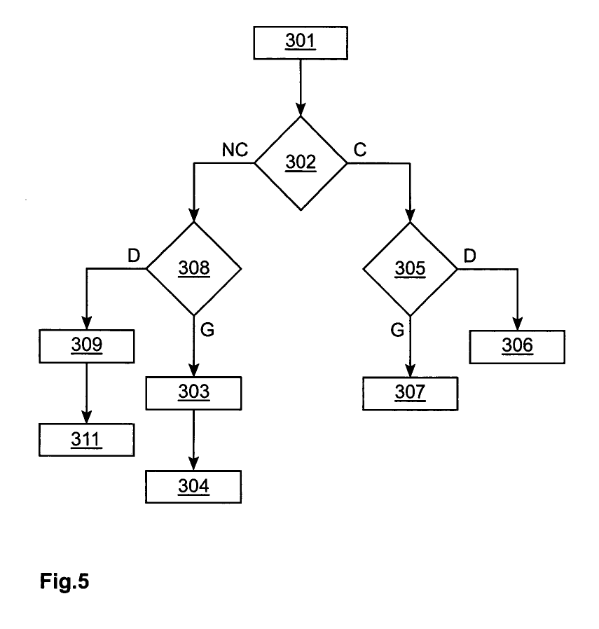

Referring now to FIG. 5, in a particularly preferred embodiment of the present invention, in the event that, at block 302, the access is classified into the non-critical class, then, at block 308, the access controller 280 determines whether to grant or deny the task 270 access to the object 250 in dependence on the access control data 285. If, at block 308, the access controller 280 decides to grant access at block 303, then the access controller 280 stores a record to this effect is recorded in the access log 290 at block 304. Similarly, if at block 308, the access controller 280 decides not to grant access at block 309, then the access controller 280 stores a record to this effect in the access log 290. The simple test performed at block 308 based on the access control data 285 effectively “triages” non-critical access control decisions so that processing power can be focussed instead on more complex decisions based on past event recorded in the access log 290.

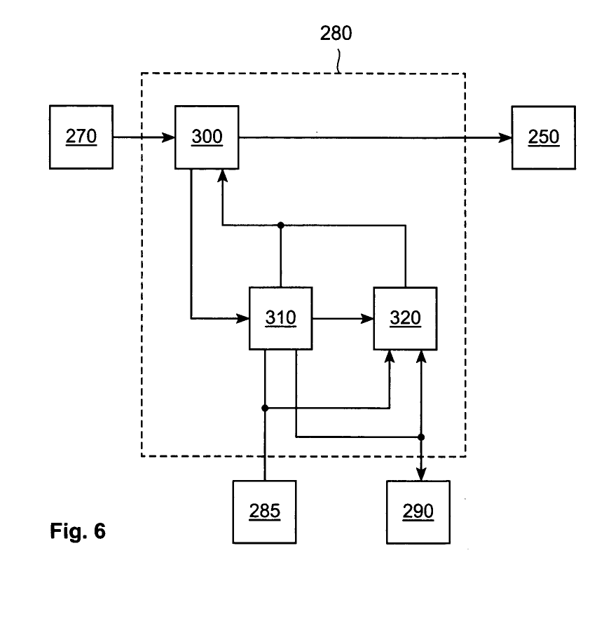

Referring now to FIG. 6 in a preferred embodiment of the present invention, the access controller 280, comprises access control logic 300 for receiving a request to access the object 250 from the task 250. Decision classifier logic 310 is connected to the access control logic 300, the access control data 285, and the access log 290 for classifying the access request into one of critical and non-critical classes in dependence on the access control data 285. If the access is classified into the non-critical class, the decision classifier logic 310 grants, the access control logic 300, the task 270 access to the object 250 and stores data indicative of the access in the access log 290. If the task is classified into the critical task, the decision classifier logic passes the request to access control decision logic 320. The access control decision logic 320 is also connected to the access control logic 300, the access log 290, and the access control data 285. On receipt of the critical access request, the access control decision logic 320, grants or denies the task 270 access to the object 250 in dependence on the contents of the access log 290 and the access control data 285.

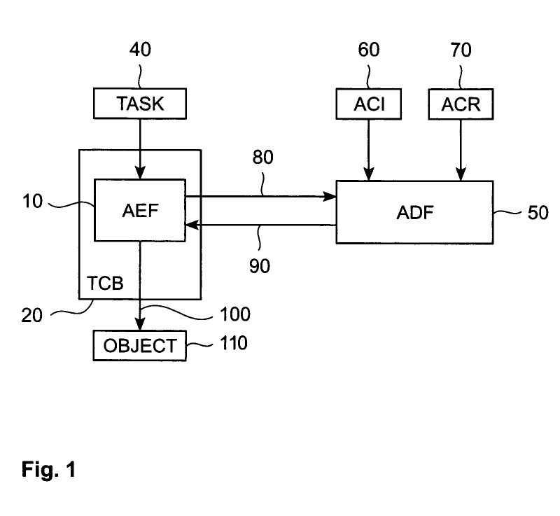

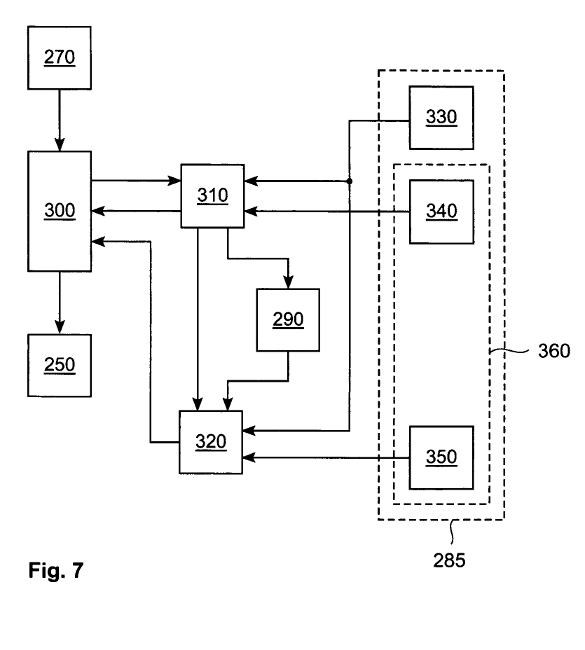

The non-critical class may be divided into multiple subclasses. Referring now to FIG. 7 in a particularly preferred embodiment of the present invention, the access control logic 300 acts as an AEF. Similarly, the decision classification logic 310 acts as a decision triager (ADT) and the access control decision logic 320 acts as an access decision facility (ADF). The access control data 285 comprises Access Control Information (ACI) 330 and Access Control Rules (ACR) 360 stored in the memory 220. The ACI 330 is substantially as herein before described with reference to FIG. 1. In operation, the AEF 300 receives an access request from the task 270. As indicated earlier, the task 270 may be a proxy for a subject in the data processing system, such as a user or a process. The task 270 makes the request because it desires access to the object 250. In response to the request, the AEF 300 generates a decision request. The decision request is routed to the ADT 360. The ADT 310 uses the ACR 360 and ACI 330 to sort the decision request into one of the aforementioned three classes of access; namely:

1. informational access control;

2. immediate access control; and,

3. deferred access control.

Here, Class 2 is the critical class. Classes 1 and 3 are subclasses of the non-critical class. The ACI 330 associates the object 290 with a set of access classes. The ACI 330 also associates the task 270 with a set of access classes. In typical implementations of access control, the ACR 360 and the ACI 330 corresponding to the subject and the object are used to check whether or not access to the object may be granted to the subject. The ACR 360 is divided into two sets of rules. Specifically, the ACR 360 comprises decision rules 340 and triage rules 350. The triage rules 340 are used by the ADT 310 in combination with the ACI 330 to classify access requests into one of the aforementioned classes. The decision rules 350 are used by the ADF 320 in combination with the ACI 330.

If the ADT 310 assigns the decision request to Class 1 or Class 3, a corresponding default decision is sent from the ADT 310 back to the AEF 300. A corresponding access record is simultaneously stored in the access log 290.

If the ADT 310 assigns the decision request to Class 2, then the ADT 310 forwards the decision request to the ADF 320 for further resolution. The ADF 320 uses the contents of the access log 290, the ACI 330, the decision rules 350, and the decision request to arrive at a decision. The ADT 320 returns the decision to the AEF 300. The decision may be a grant decision or a signal to raise an exception. The exception decision may additionally trigger recovery actions. Examples of recovery actions will described shortly.

In a particularly preferred embodiment of present invention, the ADT 310 is implemented as a lightweight process and the ADF 320 exerts more effort in arriving at the decision. The ADF 320 may choose to evaluate the contents of the LOG 390 without stimulus if, for example, system utilization is low.

The ADT 310 can be employed to perform make relatively non-critical decisions herein before described with reference to FIG. 5, block 308, leaving the ADF 320 to handle only the more critical decisions. The ADF 320 is not therefore burdened with non-critical activities. Thus, performance of the access controller 280 is greatly improved.

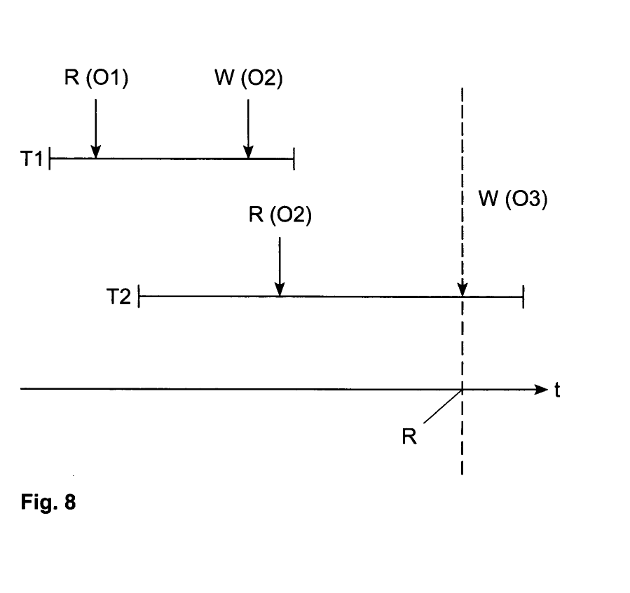

In FIG. 8, there is shown an example of an privacy access scenario relating to objects in an enterprise. In the scenario, there are two tasks, T1 and T2, operating on three objects O1, O2 and O3. O3 is a publicly accessible resource. Write operations directed to O3 are Class 2, immediate access control, because they have the potential to publicly expose sensitive data. O1 and O2 are both internal resources of the enterprise. Thus, O1 and O2 demand non-critical classification in Classes 1 or 3, deferred and informational access control respectively. Only O1 contains sensitive data such as personal data. T1 and T2 operate unhindered until, at resolution point R, T2 specifies a write operation to O3. At this point, the ADT 310 determines that the attention of the ADF 320 is required. The access rules in this example specify that data exposed publicly, such as that contained in O3, may not be tainted by sensitive data, such as that contained in O1. In addition, the access rules in this example specify that information flows relating to O3 must be examined. In this example, T1 writes to O2 after reading from O1, where sensitive data resides. Thereafter, O2 is potentially tainted by the contents of O1. T2 subsequently reads from potentially tainted O2. Then T2 attempts to write to O3. The ADF 320 detects via the contents of the access log 290 that T2 has read from O2 after T1 has written to O2 having previously read from O1. The ADF 320 thus detects that there is potential for O3 to be tainted by sensitive data contained in O1. Accordingly, the ADT 320 determines that access to O3 by T2 should be denied. In a preferred embodiment of the present invention, the ADF 320 raises an exception to prevent further disclosures. In a particularly preferred embodiment of the present invention, T1 and T2 can be rolled back based on stored recovery data so that O2 is no longer potentially tainted by the contents of O1.

The present invention permits deferral of access control decisions that may be complex from a computational standpoint to shortly before sensitive information is about to be leaked. This advantageously avoids performing such computations in real-time.

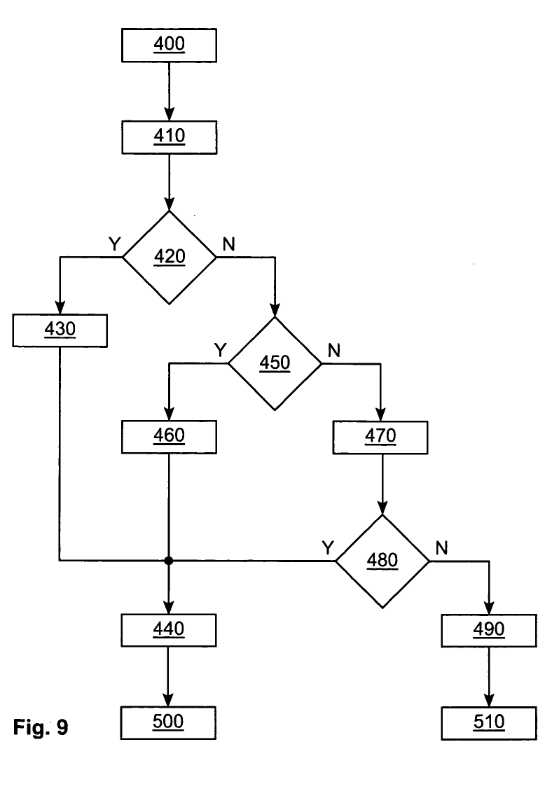

Operation of the embodiment of the present invention herein before described with reference to FIG. 7 will now described with reference to the flow chart provided in FIG. 9.

At block 400, an access request arrives at the AEF 300 from the task 270.

At block 410 the AEF 300 sends a decision request based on the access request to the ADT 310. On receipt of the decision request, the ADT 310 classifies the access corresponding to the decision request into one of the aforementioned three classes.

At block 420, if the access is determined to be in Class 1, informational access control, then, at block 430, a record of the access is saved in the access log 290. At block 440, a decision to grant the access is then sent back to the AEF 300 from the ADT 310. If the access is not determined to be in Class 1, then the test at block 450 is performed.

At block 450, if the access is determined to be in Class 3, deferred access control, then, at block 460, a record of the access is saved in the access log 290 together with recovery data. Again, at block 440, a decision to grant the access is then sent back to the AEF 300 from the ADT 310. If the access is not determined to be in Class 3, then, at block 470, the decision request is forwarded from the ADT 310 to the ADF 320. If the access is not determined to be in Class 1 or Class 3, then, by default, the access is determined to be in Class 2, immediate access control.

On receipt of the decision request at block 470, the ADF 320 evaluates the request based on the access requested, and the contents of the access log 290. If, at block 480, the ADT 320 determines from the evaluation that access should be granted, then, at block 440, the ADT 320 issues a decision to this effect to the AEF 300. If, at block 480, the ADT 320 determines from the evaluation that access should be denied, then, at block 490, the ADT 320 sends a decision to this effect back to the AEF 300.

At block 500, on receipt of a grant decision from the ADF 320 and the ADT 310, the AEF 300 grants the task 270 access to the object 250. At block 510, on receipt of a deny decision from the ADF 320, the AEF 300 denies the task 270 access to the object 250. In the event that the AEF 300 is in receipt of a deny decision from the ADF 320, additional action may be required, such as aborting the task 270 and raising an exception or rolling back all actions of the task 270 and the dependencies of such actions based on stored recovery data.

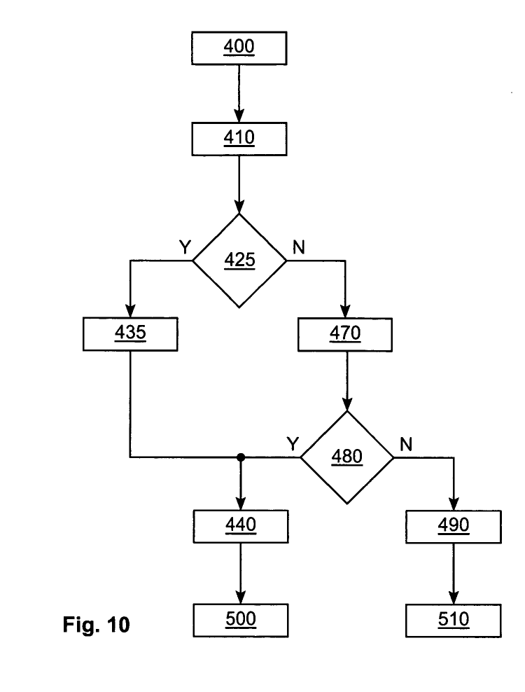

Referring to FIG. 10, in another embodiment the present invention, the non-critical class is not subdivided into subclasses. Instead, the test herein before described with reference to FIG. 9, block 420 is replaced with test simply to determine whether the access is critical or non-critical. See FIG. 10, block 425. If the access is non-critical, then, at block 435, a record of the access is saved in the access log 290 together with recovery data. If the access is critical, then, at block 470, the decision is passed to the ADF 320 as herein before described with reference to FIG. 9.

As indicated earlier, recovery data may be recorded in the access log 290. The recovery data permits the data processing system to be rolled back to a secure state. In other words, the recovery data permits the data process system to reset itself to the state it enjoyed prior to a bad access grant decision being made. In particularly preferred embodiment of the present invention, the recovery data recorded in the access log 290 comprises change data indicative of changes made to objects when the objects are accessed. Such changes may be additive, such as adding data to files. Alternatively, such changes may be subtractive, such as deleting data from files. The changes include overwriting data in files. It will be appreciated that such changes are generally associated with write operations. In a particularly preferred embodiment of the present invention, each time such changes are made, data indicative of the difference in object content before and after an access was allowed based on a potentially bad grant decision. By recording such difference data, object content prior to the access can be restored in the event that the potentially bad grant decision is determined to be actually bad.

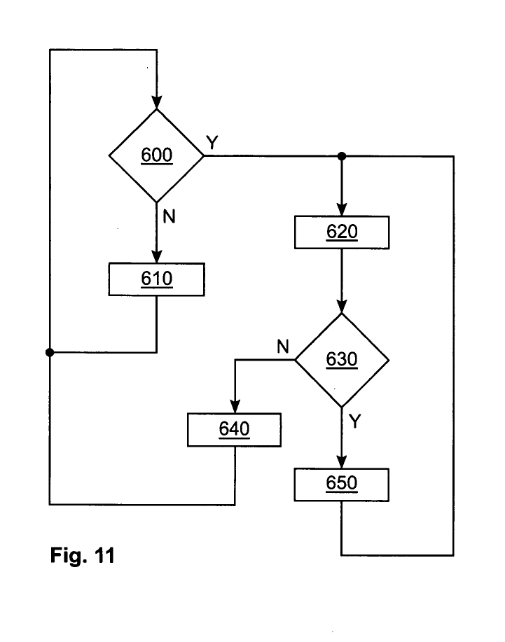

Referring to FIG. 11, in a preferred embodiment of the present invention, the access log 290 is periodically checked to determine if bad grant decisions have been issued, necessitating remedial action. Specifically, at block 600, a count is checked by the access controller 280.

If the count is not reached, then, at block 610, the count is incremented and tested again. If however the count is reached, then, at block 620, the access log 290 is inspected by the ADF 320 to determine, as herein before described with reference FIG. 9 blocks 470 and 480, if any bad grant decisions have been issued. If the ADF 320 determines, at block 630, that a bad grant decision has been issued since the last inspection, then, at block 650, the ADT 320 rolls back the affected objects based on the recovery data stored in the access log 290. The access log 290 is then inspected again at block 620 to determine if any other bad grant decisions were made since the last inspection. If the ADT 320 determines at block 630 that no bad grant decisions were made since the last inspection, then at block 640, the count is reset, and retested at block 600.

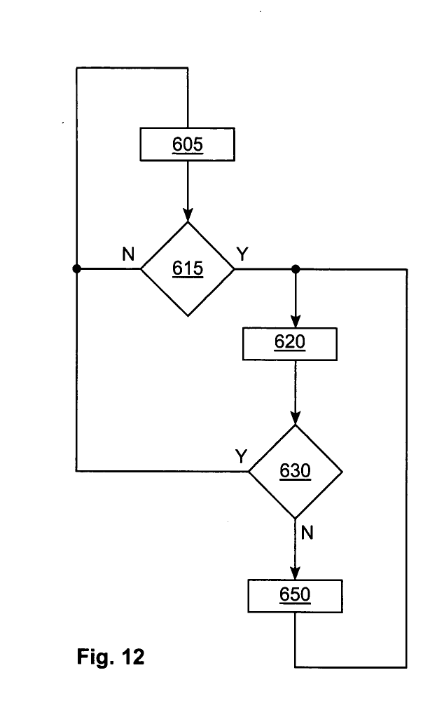

Referring to FIG. 12, in another preferred embodiment of the present invention, the access log 290 is checked during otherwise idle moments in the data processing system. Specifically, at block 605, the access controller 280 checks the state of the CPU 200. If, at block 615, the access controller 280 determines that the CPU 200, then the check at block 605, is performed again after a predetermined period. If, at block 615, the access controller 280 determines that the CPU 200 is free, then blocks 620, 630, and 650 are performed as herein before described with reference to FIG. 10. Once all bad grant decisions recorded in the access log 290 since the last inspection have been detected and restoration measures accordingly taken, the test at block 605 is repeated.

Preferred embodiments of the present invention have been herein before described with reference to computer program code for configuring the CPU 200 and the memory subsystem 220 of a data processing system to perform the functions of the access controller 280, the access control data 285, and the access log 290. It will be appreciated however, that, in other embodiments of the present invention, one or more of such functions may be performed at partially by hardwired logic or similarly dedicated circuitry. Equally, it will be appreciated that the data processing system may be embodied in a single unit or in a plurality of distributed units interconnected via data communications network.

In summary, described herein by way of example of the present invention is a method for controlling access to an object in a data processing system comprises: receiving a request to access the object from a task; classifying the access request into one of critical and non-critical classes in dependence on stored access control data associated with the object and the task; granting the task access to the object and storing data indicative of the access in an access log if the access is classified into the non-critical class; and, in the event that the access is classified into the critical class, granting or denying the task access to the object in dependence on the contents of the access log and the stored access control data. It will be appreciated that many implementation of such a method are possible.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention.

This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

Variations described for the present invention can be realized in any combination desirable for each particular application. Thus particular limitations, and/or embodiment enhancements described herein, which may have particular advantages to the particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention.

This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed, is:

1. A method for controlling access to an object in a data processing system, the method comprising:
receiving an access request to access the object from a task;
classifying the access request into one of critical and non-critical classes in dependence on stored access control data associated with the object and the task;
granting the task access to the object and storing data indicative of the access in an access log if the access is classified into the non-critical class; and,
in the event that the access is classified into the critical class, granting or denying the task access to the object in dependence on the contents of the access log and the stored access control data.

2. A method as recited in claim 1, further comprising, in the event that the access is classified into the non-critical class, granting or denying the task access to the object in dependence on the access control data, and storing data indicative of the grant or denial in the access log.

3. A method as recited in claim 1, wherein the non-critical class comprises a plurality of subclasses and the classifying comprises classifying the access request into one of the subclasses in dependence on the stored access control data.

4. A method as recited in claim 1, wherein the subclasses comprise a first subclass and a second subclass.

5. A method as recited in claim 4, further comprising storing recovery data in the access log if the access is classified into the second subclass.

6. A method as recited in claim 5, further comprising:
inspecting the access log to identify a bad grant decision based on the contents of the access log and the access control data; and,
on detection of a bad grant decision, rolling back any objects affected by the bad grant decision.

7. A method as recited in claim 6, wherein the rolling back comprises recovering data overwritten in the object.

8. A method as recited in claim 6, further comprising performing the inspecting periodically.

9. A method as recited in claim 6, further comprising performing the inspecting during periods in which the data processing system is otherwise idle.

10. An apparatus for controlling access to an object in a data processing system, the apparatus comprising: an access control data store for storing access control data associated with the object and the task; an access log;
access control logic for receiving a request to access the object from a task; decision classifier logic, connected to the access control logic, the access control data store, and the access log, for classifying the access request into one of critical and non-critical classes in dependence on the access control data, and, in the event that the access is classified into the non-critical class, for granting the task access to the object and storing data indicative of the access in the access log; and, access control decision logic connected to the access control logic, the access log, the access control data store, and the decision classifier logic, for, in the event that the access is classified into the critical class, granting or denying the task access to the object in dependence on the contents of the access log and the access control data.

11. An apparatus as recited in claim 10, wherein, in use, the decision classifier logic, in the event that the access is classified into the non-critical class, grants or denies the task access to the object in dependence on the contents of the access control data, and stores data indicative of the grant or denial in the access log.

12. An apparatus as recited in claim 10, wherein the non-critical class comprises a plurality of subclasses and the decision classifier logic, in use, classifies the access request into one of the subclasses in dependence on the access control data.

13. An apparatus as recited in claim 10, wherein the subclasses comprise a first subclass and a second subclass.

14. An apparatus as recited in claim 13, wherein the decision classifier logic, in use, stores recovery data in the access log if the access is classified into the second subclass.

15. An apparatus as recited in claim 14, wherein the access control decision logic, in use, inspects the access log to identify a bad grant decision based on the contents of the access log and the access control data, on detection of a bad grant decision, effects a roll back of any objects affected by the bad grant decision.

16. An apparatus as recited in claim 15, wherein the rolling back comprises recovering data overwritten in the object.

17. An apparatus as recited in claim 15, wherein the access control decision logic, in use, performs the inspection periodically.

18. An apparatus as recited in claim 15, wherein the access control decision logic, in use, performs the inspection during periods in which the data processing system is otherwise idle.

19. Data processing system comprising: a central processor unit; a memory; and apparatus as recited in claim 10 connected to the central processor unit and the memory.

20. Computer program element comprising computer program code means which, when loaded in a processor of a computer system, configures the processor to perform a method as recited in claim 1.

21. An article of manufacture comprising a computer usable medium having computer readable program code means embodied therein for causing control of access to an object in a data processing system, the computer readable program code means in said article of manufacture comprising computer readable program code means for causing a computer to effect the steps of claim 1.

22. A program storage device readable by machine, tangibly embodying a program of instructions executable by the machine to perform method steps for controlling access to an object in a data processing system, said method steps comprising the steps of claim 1.

23. A computer program product comprising a computer usable medium having computer readable program code means embodied therein for causing control of access to an object in a data processing system, the computer readable program code means in said computer program product comprising computer readable program code means for causing a computer to effect the functions of claim 10.
